(19) United States
(12) Patent Application Publication
(10) Pub. No.: US 2017/0085566 A1
(43) Pub. Date: Mar. 23, 2017

(54) ELECTRONIC DEVICE AND CONTROL METHOD THEREOF

(71) Applicant: SAMSUNG ELECTRONICS CO., LTD., Suwon-si (KR)

(72) Inventor: Hong-jae KIM, Suwon-si (KR)

(21) Appl. No.: 15/233,033

(22) Filed: Aug. 10, 2016

(30) Foreign Application Priority Data
Sep. 18, 2015 (KR) 10-2015-0132266

(51) Int. Cl. H04L 29/06

(52) U.S. Cl. CPC H04L 63/0876; H04L 65/1069

(57) ABSTRACT

An electronic device is disclosed, the electronic device including: a communicator comprising communication circuitry configured to search for a communication relay device and to connect with a network through the communication relay device identified by the search; a storage configured to store identification information of at least one communication relay device which has been previously used for connection with the network; and a controller configured to receive the identification information of the identified communication relay device, to determine whether a service environment of the electronic device is valid based on the received identification information and the stored identification information of at least one communication relay device, and to perform a preset device-protecting operation if it is determined that the service environment of the electronic device is not valid.

Thus, a neighboring AP may be identified and it is determined whether the service environment of the electronic device is valid, thereby controlling the authorized use of the electronic device.

### CROSS-REFERENCE TO RELATED APPLICATION

This application is based on and claims priority under 35 U.S.C. §119 to Korean Patent Application No. 10-2015-0132266 filed on Sep. 18, 2015 in the Korean Intellectual Property Office, the disclosure of which is incorporated by reference herein in its entirety.

### BACKGROUND

Field

Disclosed apparatuses and methods relate generally to an electronic device and a control method thereof, and for example to an electronic device and a control method thereof, in which a neighboring access point (AP) is identified to control use of the electronic device.

Description of Related Art

In case of a television (TV) used at home, it has been changed into a smart TV having functions like a smart phone, and thus deals with a lot of personal information such as a picture, a moving picture, etc. Generally, the TV has used a coding method for protecting the personal information.

Besides the TV, many home appliances have become smart. For example, a robot cleaner, a microwave oven, an air conditioner, a washing machine, a loudspeaker and the like home appliances have changed to support a function of Wi-Fi. However, such a smart home appliance is vulnerable to theft since it is expensive and easily usable by others.

However, the coding method generally used for the TV is inappropriate to be applied to the smart home appliances since a password has to be input at every use. Accordingly, a separate protection system is required for the smart home appliances.

### SUMMARY

Accordingly, an aspect of one or more example embodiments may provide an electronic device and a method of controlling the same, in which a neighboring access point (AP) is identified to control use of the electronic device.

Another aspect is to provide an electronic device and a control method thereof, in which a neighboring AP is identified to perform a device-protecting operation when a service environment of the electronic device is not valid.

In accordance with an example embodiment, an electronic device is provided, the electronic device comprising: a communicator comprising communication circuitry configured to search for a communication relay device and to connect with a network through the communication relay device identified by the search; a storage configured to store identification information of at least one communication relay device which has been previously used for connection with the network; and a controller configured to receive the identification information of the identified communication relay device, to determine whether a service environment of the electronic device is valid based on the received identification information and the stored identification information of at least one communication relay device, and to perform a preset device-protecting operation if it is determined that the service environment of the electronic device is not valid.

Thus, the neighboring AP is identified and it is determined whether the service environment of the electronic device is valid or not, thereby controlling the use of the electronic device. Further, the neighboring AP is identified, and the protecting operation is automatically performed if the service environment of the electronic device is not valid.

The controller may determine that the service environment of the electronic device is not valid, if the received identification information does not match the stored identification information of at least one communication relay device. Thus, if the searched neighboring AP does not match the AP previously registered by a user, it is determined that the electronic device is not usable, and therefore the protecting operation is automatically performed.

The electronic device may further comprise an input comprising input circuitry configured to receive a user's input, and the controller may be configured to determine whether or not the service environment of the electronic device is valid, based on the received user's input, if the received identification information does not match the stored identification information of at least one communication relay device. Thus, if the searched neighboring AP does not match the AP previously registered by a user, it is possible to make the electronic device be usable or not usable based on the user's input.

The user's input may include at least one input among a numeral key, combination of buttons provided in the remote controller, and combination of panel keys provided outside the electronic device. Thus, if the searched neighboring AP does not match the AP previously registered by a user, the use of the electronic device is controllable based on the user's input using various input means provided in the electronic device.

The controller may determine whether or not the service environment of the electronic device is valid, based on whether communication with a preset user's wireless communication device is possible, if the received identification information does not match the stored identification information of at least one communication relay device. Thus, if the searched neighboring AP does not match the AP previously registered by a user, it is possible to control the electronic device be usable or not usable in based on whether communication with a user's smart phone is possible through Wi-Fi or Bluetooth.

The electronic device may further comprise a camera configured to photograph a surrounding environment, and the controller may determine whether or not the service environment of the electronic device is valid, based on whether a picture of the surrounding environment photographed by the camera is similar to one of previously stored pictures of surrounding environments, if the received identification information does not match the stored identification information of at least one communication relay device. Thus, if the searched neighboring AP does not match the AP previously registered by a user, it is possible to control the electronic device be usable or not usable based on comparison between the picture of the surrounding environment photographed by the camera provided in the electronic device and the pictures of the surrounding environments previously registered by a user.

The device-protecting operation may comprise an operation of preventing at least one function, which can be provided by the electronic device, from being implemented. Thus, if the searched neighboring AP does not match the AP previously registered by a user, it is possible to perform the protecting operation by preventing the electronic device from operating or a certain function of the electronic device from being implemented.

The device-protecting operation may comprise an operation of sending a preset user's wireless communication device at least one of information of warning that the service environment of the electronic device is not valid, and information about a location of the electronic device. Thus, if the searched neighboring AP does not match the AP previously registered by a user, it is possible to inform a user that there is a problem in the service environment of the electronic device or to send the place information of the electronic device.

The identification information of the communication relay device may comprise at least one of service set identifier (SSID) and media access control (MAC) address. Thus, it is possible to determine whether the service environment of the electronic device is changed, by monitoring at least one of the SSID and the MAC address of the neighboring AP.

The controller may control the storage to store the received identification information of the communication relay device if the received identification information does not match the stored identification information of at least one communication relay device and the service environment of the electronic device is valid. Thus, if it is determined that the service environment is valid based on the received user's input, the photographed picture of the surrounding environment, communication with a user's wireless communication device, etc. even though the searched neighboring AP does not match the AP previously registered by a user, it is possible to register and use the searched neighboring AP.

The electronic device may further comprise an input comprising input circuitry configured to receive a user's input, and the controller may receive the user's input selecting a normal mode or an antitheft mode, and determines whether or not the service environment of the electronic device is valid, based on the received identification information and the stored identification information of at least one communication relay device, if the antitheft mode is selected. Thus, if the electronic device is in the antitheft mode, it is possible to determine whether the service environment of the electronic device is valid or invalid based on matching between the searched neighboring AP and the AP previously registered by a user.

In accordance with an example embodiment, a method of controlling an electronic device is provided, the method comprising: storing identification information of at least one communication relay device which has been previously used for connection with a network; searching for a communication relay device; receiving the identification information of the searched communication relay device; determining whether or not a service environment of the electronic device is valid based on the received identification information and the stored identification information of at least one communication relay device; and performing a preset device-protecting operation to be performed if it is determined that the service environment of the electronic device is not valid.

Thus, the neighboring AP is identified and it is determined whether the service environment of the electronic device is valid or not, thereby controlling the use of the electronic device. Further, the neighboring AP is identified, and the protecting operation is automatically performed if the service environment of the electronic device is not valid.

The method may further comprise determining that the service environment of the electronic device is not valid, if the received identification information does not match the stored identification information of at least one communication relay device. Thus, if the searched neighboring AP does not match the AP previously registered by a user, it is determined that the electronic device is not usable, and therefore the protecting operation is automatically performed.

The method may further comprise determining whether or not the service environment of the electronic device is valid, based on a received user's input, if the received identification information does not match the stored identification information of at least one communication relay device. Thus, if the searched neighboring AP does not match the AP previously registered by a user, it is possible to make the electronic device be usable or not usable based on the user's input.

The user's input may comprise include at least one input among a numeral key, combination of buttons provided in the remote controller, and combination of panel keys provided outside the electronic device. Thus, if the searched neighboring AP does not match the AP previously registered by a user, the use of the electronic device is controllable based on the user's input using various input means provided in the electronic device.

The method may further comprise determining whether or not the service environment of the electronic device is valid, based on whether communication with a preset user's wireless communication device is possible, if the received identification information does not match the stored identification information of at least one communication relay device. Thus, if the searched neighboring AP does not match the AP previously registered by a user, it is possible to control the electronic device be usable or not usable in accordance with whether communication with a user's smart phone is possible through Wi-Fi or Bluetooth.

The method may further comprise determining whether or not the service environment of the electronic device is valid, based on whether a picture of a surrounding environment photographed by a camera is similar to one of previously stored pictures of surrounding environments, if the received identification information does not match the stored identification information of at least one communication relay device. Thus, if the searched neighboring AP does not match the AP previously registered by a user, it is possible to control the electronic device be usable or not usable based on comparison between the picture of the surrounding environment photographed by the camera provided in the electronic device and the pictures of the surrounding environments previously registered by a user.

The device-protecting operation may comprise an operation of preventing at least one function, which can be provided by the electronic device, from being implemented. Thus, if the searched neighboring AP does not match the AP previously registered by a user, it is possible to perform the protecting operation by preventing the electronic device from operating or a certain function of the electronic device from being implemented.

The device-protecting operation may comprise an operation of sending a preset user's wireless communication device at least one of information of warning that the service environment of the electronic device is not valid, and information about a place of the electronic device. Thus, if the searched neighboring AP does not match the AP previously registered by a user, it is possible to inform a user that there is a problem in the service environment of the electronic device or to send the place information of the electronic device.

The identification information of the communication relay device may comprise at least one of service set identifier (SSID) and media access control (MAC) address. Thus, it is possible to determine whether the service environment of the electronic device is changed, by monitoring at least one of the SSID and the MAC address of the neighboring AP.

The method may further comprise storing the received identification information of the communication relay device if the received identification information does not match the stored identification information of at least one communication relay device and the service environment of the electronic device is valid. Thus, if it is determined that the service environment is valid based on the user's input, the photographed picture of the surrounding environment, communication with a user's wireless communication device, etc. even though the searched neighboring AP does not match the AP previously registered by a user, it is possible to register and use the searched neighboring AP.

The method may further comprise receiving the user's input selecting a normal mode or an antitheft mode; and determining whether or not the service environment of the electronic device is valid, based on the received identification information and the stored identification information of at least one communication relay device, if the antitheft mode is selected. Thus, if the electronic device is in the antitheft mode, it is possible to determine whether the service environment of the electronic device is valid or invalid based on matching between the searched neighboring AP and the AP previously registered by a user.

### BRIEF DESCRIPTION OF THE DRAWINGS

The above and/or other aspects will become apparent and more readily appreciated from the following detailed description, taken in conjunction with the accompanying drawings, in which like reference numerals refer to like elements, and wherein:

FIG. 1 is a block diagram illustrating an example electronic device according to an example embodiment;

FIG. 2 is a block diagram illustrating an example display apparatus according to an example embodiment;

FIG. 3 is a flowchart illustrating an example of controlling the electronic device according to an example embodiment;

FIG. 4 is a flowchart illustrating an example of controlling the electronic device according to an example embodiment;

FIG. 5 is a flowchart illustrating an example of controlling the electronic device according to an example embodiment;

FIG. 6 is a diagram illustrating an example of registering access points (Aps) to which a user has an access in various places according to an example embodiment;

FIG. 7 is a diagram illustrating an example of displaying all the APs registered according to an example embodiment;

FIGS. 8A and 8B are diagrams illustrating an example of determining change in place of the electronic device based on identification information of the AP searched according to an example embodiment;

FIG. 9 is a diagram illustrating an example of displaying APs newly searched according to an example embodiment;

FIG. 10 is a diagram illustrating an example of performing a device-protecting operation if the searched AP is not registered according to an example embodiment;

FIG. 11 is a diagram illustrating an example of displaying a user interface (UI) for performing user authentication if the searched AP is not registered according to an example embodiment;

FIG. 12 is a diagram illustrating an example of displaying a UI for registering the searched AP by a user based on the user authentication according to an example embodiment;

FIG. 13 is a diagram illustrating an example of displaying a UI for registering the searched AP based on the user authentication if the searched AP is not registered, according to an example embodiment;

FIG. 14 is a diagram illustrating an example of displaying a UI for accessing the newly registered AP according to an example embodiment;

FIG. 15 is a diagram illustrating an example of performing the device-protecting operation when the user authentication is failed, according to an example embodiment;

FIGS. 16A and 16B are diagrams illustrating an example of determining whether communication with a user's wireless communication device is possible or not if the searched AP is not registered, according to an example embodiment;

FIGS. 17A and 17B are diagrams illustrating an example of comparing a photographed picture of a surrounding environment with previously registered pictures of the surrounding environments if the searched AP is not registered, according to an example embodiment;

FIGS. 18A and 18B are diagrams illustrating an example of transmitting warning information or place information to a user's wireless communication device if the searched AP is not registered, according to an example embodiment;

FIG. 19 is a diagram illustrating an example where new APs are searched as the electronic device according to an example embodiment is changed in place;

FIG. 20 is a diagram illustrating an example of performing the device-protecting operation if the searched AP is not registered, according to an example embodiment;

FIG. 21 is a diagram illustrating an example of displaying a UI for performing the user authentication if the searched AP is not registered, according to an example embodiment; and

FIG. 22 is a diagram illustrating an example of performing the user authentication based on voice recognition if the searched AP is not registered, according to an example embodiment.

### DETAILED DESCRIPTION

Below, example embodiments will be described in detail with reference to accompanying drawings. The present disclosure may be achieved in various forms and not limited to the following example embodiments. For convenience of description, parts not directly related to the present disclosure may be omitted, and like numerals refer to like elements throughout.

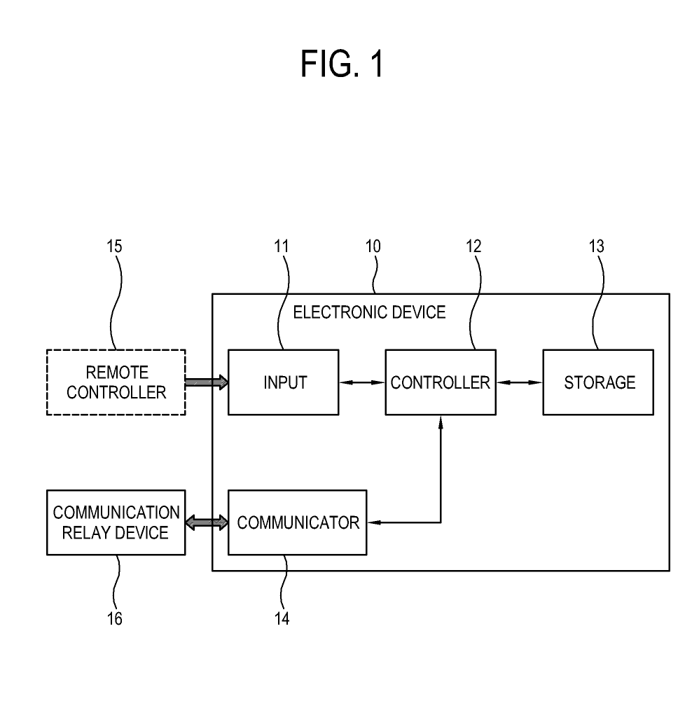

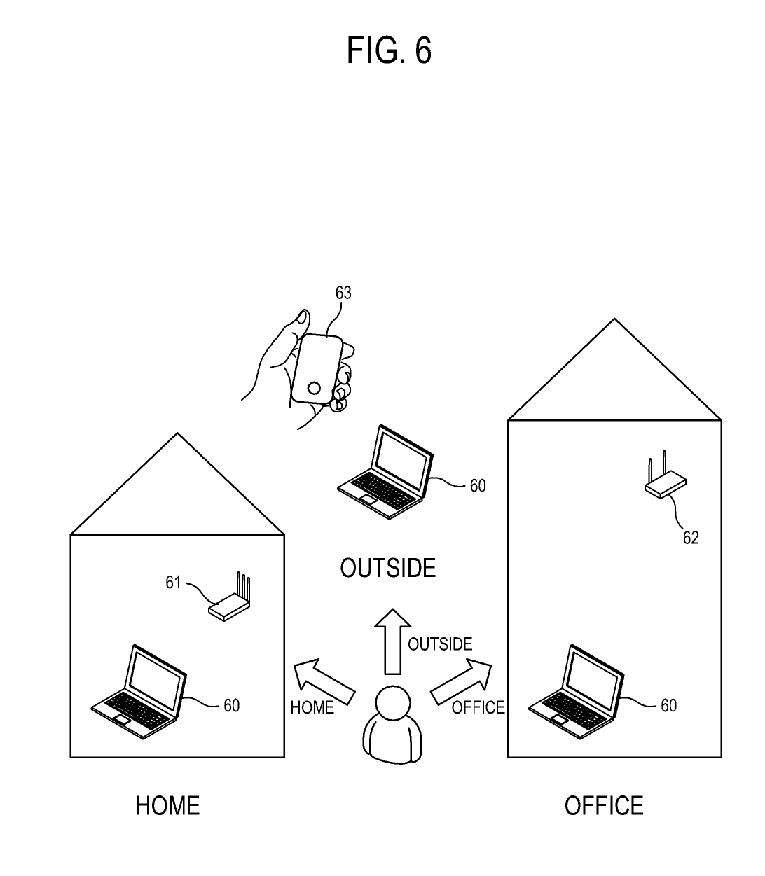

First, elements included in an electronic device according to an exemplary embodiment will be described in greater detail with reference to FIG. 1, and FIGS. 6 to 22 will be also referred to, as necessary. FIG. 1 is a block diagram illustrating an example electronic device according to an example embodiment. As illustrated in FIG. 1, an electronic device 10 according to this example embodiment includes an input (e.g., including input circuitry for receiving, for example, a user input) 11, a controller 12, a storage 13 and a communicator (e.g., including communication circuitry) 14, and may for example be achieved by a smart TV, a smart phone, a tablet computer, a personal computer (PC), a netbook computer, a notebook computer or the like display apparatus. Further, the electronic device 10 may be achieved by a robot cleaner, a microwave oven, an air conditioner, a washing machine, a loudspeaker and the like home appliances that support a function of wireless fidelity (Wi-Fi). The electronic device 10 may connect with a communication relay device 16 through Wi-Fi or the like communication method. The communication relay device 16 serves as an access point (AP). The communication relay device 16 is one of elements that constitute a wireless local area network (WLAN), and has functions of routing and network address translation (NAT). For example, the communication relay device 16 may serve as a relay for connecting with a wired LAN for an Internet service. The communication relay device 16 may form example be achieved by a wireless router. The elements involved in the electronic device 10 according to this example embodiment are not limited to the foregoing description, and may further include additional other elements.

The electronic device 10 searches for the communication relay device 16, and has an access to a network through the searched communication relay device 16. The electronic device 10 stores identification information about at least one communication relay device 16 that has been employed for having the access to the network. The electronic device 10 receives the identification information of the searched communication relay device 16, and determines whether a service environment for the electronic device 10 is valid or not based on the received identification information and the stored identification information of at least one communication relay device 16. If it is determined that the service environment is not valid, the electronic device 10 may perform a preset device-protecting operation.

According to an example embodiment, the electronic device 10 identifies a neighboring AP and determines whether the neighboring AP is usable or not for the electronic device 10, thereby having an advantage of controlling the use of the electronic device 10. Further, if the service environment of the electronic device 10 is not valid based on the identification of the neighboring AP, the protecting operation may be automatically performed.

The communicator 14 searches the communication relay device 16. The communicator 14 may communicate with the communication relay device 16 through various communication circuitry, including, for example, and without limitation, infrared communication, Wi-Fi, Bluetooth, etc. The communicator 14 may be connected to the network via the searched communication relay device 16. The communicator 14 may be connected to the wired LAN for the Internet service through the communication relay device 16.

The storage 13 stores the identification information of at least one communication relay device that has been previously used for the connection with the network. For example, the storage 13 may store at least one of service set identifier (SSID) and media access control (MAC) address of the AP to which a user has had an access for using the Internet. The SSID is a unique identifier attached to each header of packets to be transmitted through the wireless LAN, and serves to distinguish a certain wireless LAN from other wireless LANs. The MAC address is a unique identifier given to a network adapter, and different APs have different MAC addresses. Therefore, at least one communication relay device may be identified based on the SSID or MAC address. According to an example embodiment, as illustrated in FIG. 6, the storage 13 may store identification information corresponding to a plurality of APs that have been accessed for using the Internet by a user at home, office or the outside.

Alternatively, the storage 13 may store the identification information of at least one communication relay device that has been searched under the condition that a user is identified. For instance, if a user searches a communication relay device at home, the storage 13 may store the SSID and MAC address of not only a user's accessible wireless router but also neighbors' searched wireless routers even though they are inaccessible.

The input 11 may include, for example, and without limitation, circuitry that receives a user's input for controlling at least one function of the electronic device 10. The input 11 may include various circuitry including, for example, and without limitation, a keyboard, a mouse, etc., and may also be achieved in the form of an input panel provided outside the electronic device 10. According to an example embodiment, the input 11 may receive a user's input from a remote controller 15. According to an example embodiment, the user's input may include at least one input among a numeral key, combination of buttons provided in the remote controller, and combination of panel keys provided outside the electronic device 10.

The controller 12 receives the identification information of the searched communication relay device 16 through the communicator 14. The identification information of the communication relay device 16 may include at least one of the SSID and the MAC address. The controller 12 determines whether the service environment of the electronic device 10 is valid or invalid based on the received identification information of the communication relay device 16 and the stored identification information of at least one communication relay device.

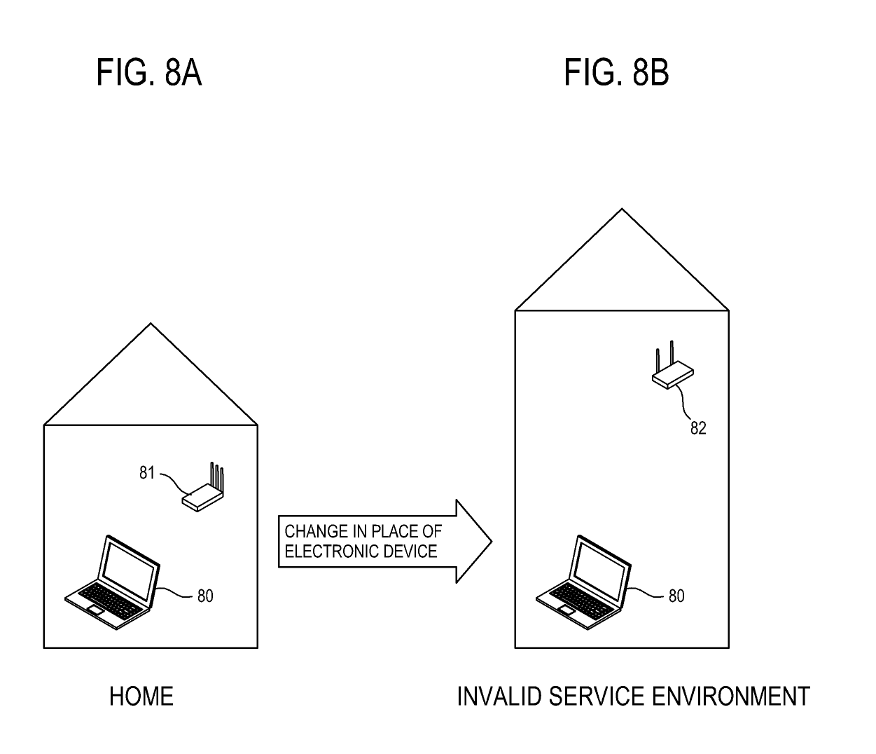

According to an example embodiment, the controller 12 may determine that the service environment of the electronic device 10 is not valid, if the received identification information of the communication relay device 16 matches one among the pieces of the stored identification information about at least one communication relay device. For example, as illustrated in FIG. 8A, if a notebook computer 80 is being used at home, it is connected to the network via a first wireless router 81, and the SSID and MAC address of the first wireless router 81 are stored in the storage 13. Then, if the notebook computer 80 is changed in place as illustrated, for example, in FIG. 8B, it searches neighboring second wireless routers 82 in order to access the network. At this time, if the SSID or MAC address of the searched second wireless routers 82 does not match the SSID or MAC address of the first wireless router previously stored in the storage 13, it may be determined that the notebook computer 80 is placed under an invalid service environment.

According to an example embodiment, the controller 12 receives the identification information about the plurality of searched communication relay devices 16 through the communicator 14, and determines whether the service environment of the electronic device 10 is valid based on the number of communication relay devices 16, the received identification information of which matches the identification information of at least one communication relay device stored in the storage 13, among the plurality of communication relay devices 16. At this time, the identification information of at least one communication relay device, which is stored in the storage 13, may be the identification information of the communication relay device, which has been searched under the condition that a user is authenticated, even though the communication relay device has not been used for the connection with the network. For example, if a predetermined number or more of SSID or MAC addresses of the plurality of wireless routers searched by the notebook computer matches the stored SSID or MAC address of the wireless routers, it is determined that the service environment of the notebook computer is valid. On the other hand, if a predetermined number or more of SSID or MAC addresses of the plurality of wireless routers searched by the notebook computer does not match the stored SSID or MAC address of the wireless routers, it is determined that the service environment of the notebook computer is invalid.

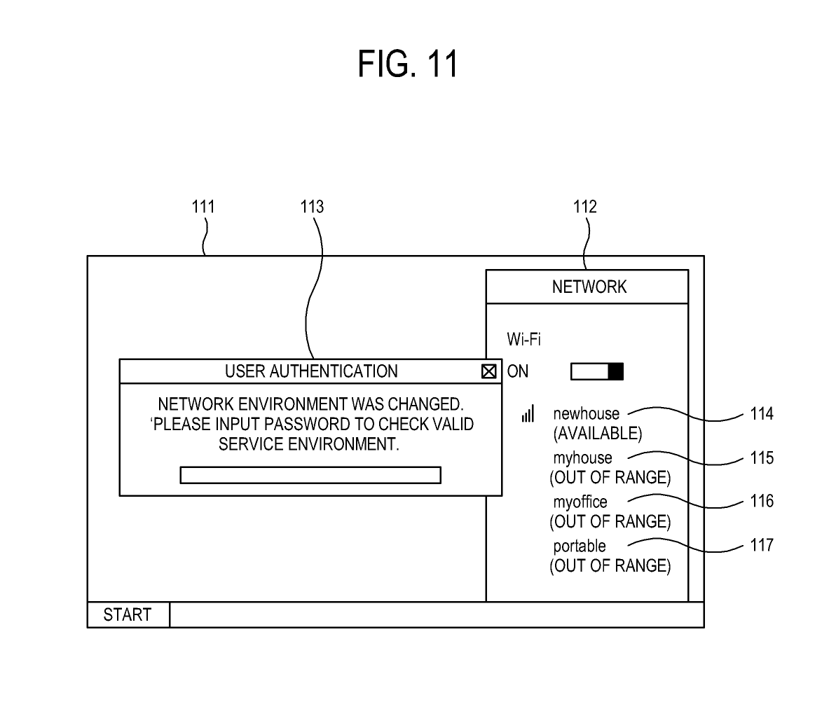

According to an example embodiment, the controller 12 may determine whether the service environment of the electronic device 10 is valid based on a received user's input, if the received identification information of the communication relay device 16 does not match one among the pieces of stored identification information about at least one communication relay device. The user's input may include at least one input among a numeral key, combination of buttons provided in the remote controller, and combination of panel keys provided outside the electronic device 10. For example, as illustrated in FIG. 11, a notebook computer 111 may display a UI 113 for user authentication if “newhouse” 114 is searched as a new AP not registered previously in a network setup window 112. If a user's password is input through the UI 113 for the user authentication, the notebook computer 111 determines whether the service environment is valid in accordance with matching between the input password and his/her preset password.

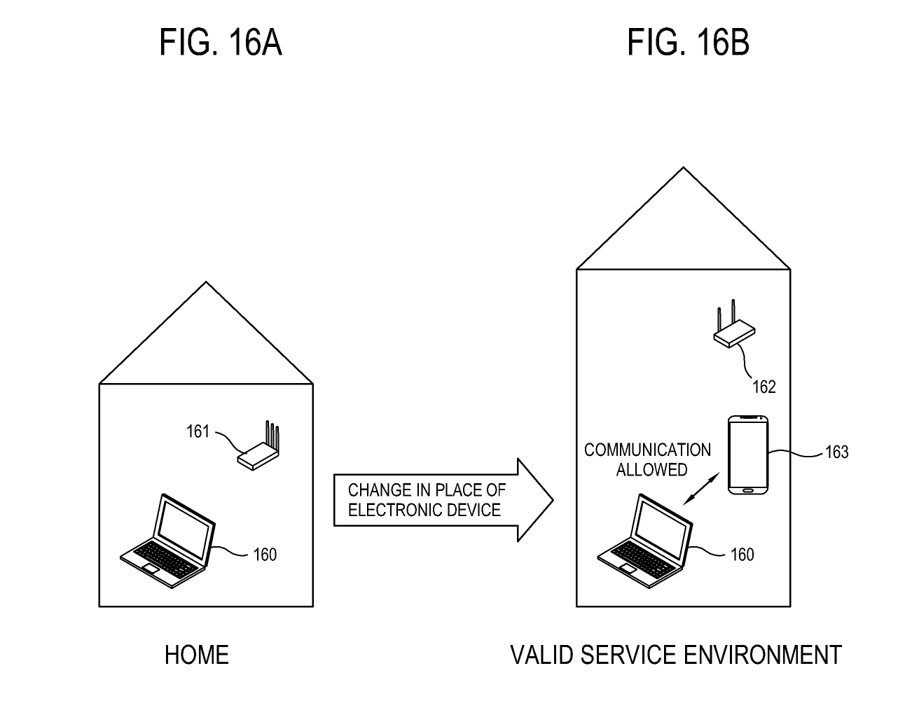

Alternatively, the controller 12 may determine whether the service environment of the electronic device 10 is valid based on whether communication with a user's preset wireless communication device is possible, if the received identification information of the communication relay device 16 does not match one among the pieces of previously stored identification information of the at least one communication relay device. For example, as illustrated in FIG. 16A, if a notebook computer 160 is being used at home, it is connected to the network via a first wireless router 161 and the SSID and MAC address of the first wireless router 161 are stored in the storage 13. The notebook computer 160 is changed in place as illustrated, for example, in FIG. 16B, a neighboring second wireless router 162 is searched for connecting with the network. At this time, if the SSID or MAC address of the searched second wireless router 162 matches the SSID or MAC address of the first wireless router 161 previously stored in the storage 13, the notebook computer 160 makes an attempt to communicate with a user's smart phone 163 previously set by him/her. If the notebook computer 160 connects with a user's smart phone 163 through short range communication such as Wi-Fi direct or Bluetooth, it is determined that the service environment for the notebook computer 160 is valid. On the other hand, if the notebook computer 160 fails in connecting with a user's smart phone 163, it is determined that the service environment for the notebook computer 160 is invalid.

Alternatively, the electronic device 10 may further include a camera (not shown) for photographing a surrounding environment. In this case, the controller 12 may determine whether the service environment of the electronic device 10 is valid or invalid based on whether or not a picture of a surrounding environment photographed by the camera is similar to a previously stored picture of the surrounding environment, if the received identification information of the communication relay device 16 does not match the previously stored identification information of at least one communication relay device.

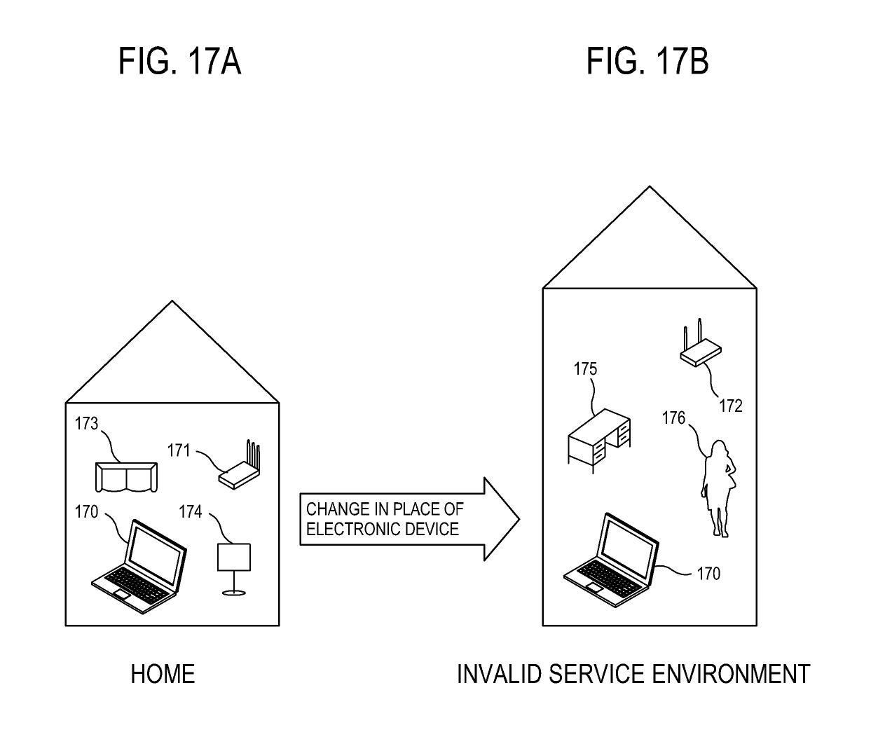

For example, as illustrated in FIG. 17A, if the notebook computer 170 is being used at home, it is connected to the network through a first wireless router 171, and the SSID and MAC address of the first wireless router 171 are stored in the storage 13. If the notebook computer 170 is changed in place as illustrated, for example, in FIG. 17B, a neighboring second wireless router 172 is searched for connecting with the network. At this time, if the SSID or MAC address of the searched second wireless router 172 does not match the SSID or MAC address of the first wireless router 171 previously stored in the storage 13, the notebook computer 170 activates a webcam to take a picture of the surrounding environment. The picture of the surrounding environment photographed by the webcam may contain a desk 175, a person 176 or the like object. The notebook computer 170 may store the picture of the surrounding environment generally used by a user in the storage 13, in which the stored picture of the surrounding environment may contain an object such as a sofa 173, a lamp 174, etc. The notebook computer 170 compares the taken picture of the surrounding environment with the stored picture of the surrounding environment, and determines that the service environment of the notebook computer 170 is not valid if there are no same objects between the taken and stored pictures.

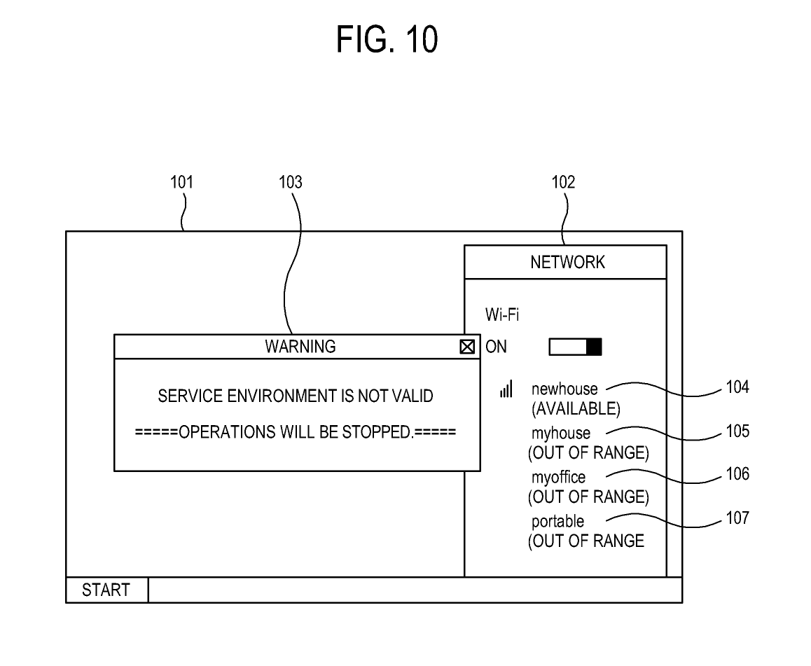

If it is determined that the service environment of the notebook computer 170 is not valid, the controller 12 controls a preset device-protecting operation to be performed. According to an example embodiment, the device-protecting operation may include an operation for stopping at least one function that can be provided by the electronic device 10. For example, as illustrated in FIG. 10, a notebook computer 101 may display a warning window 103 and stop operating if “newhouse” 104 is searched as a new AP not registered in a network setup window 102.

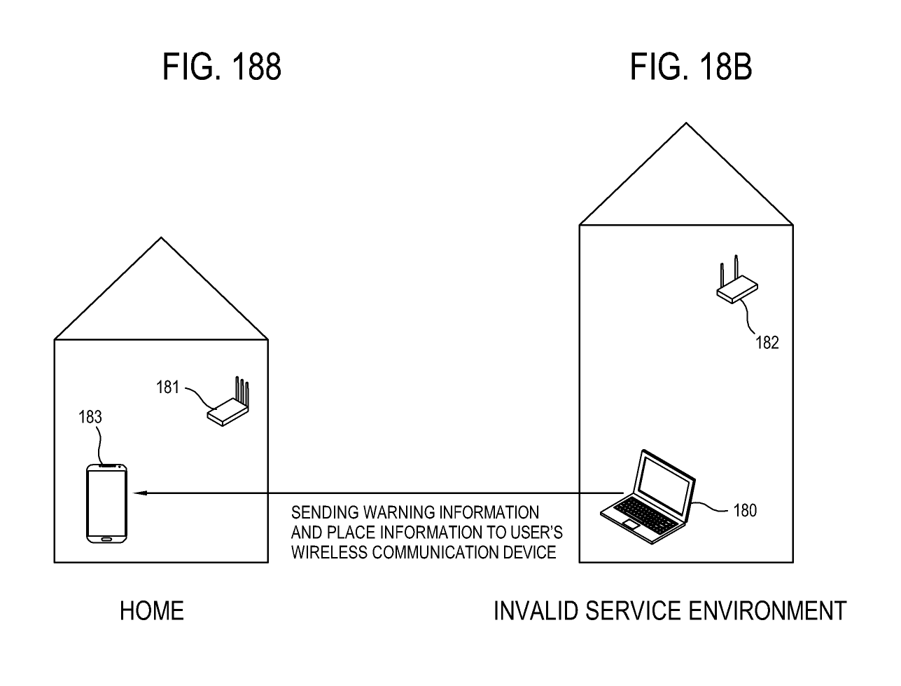

Alternatively, the device-protecting operation may include sending a preset user's wireless communication device at least one of information for warning that the service environment of the electronic device 10 is not valid, and information about the place of the electronic device 10. For example, as illustrated in FIG. 18A, if a notebook computer 180 is being used at home, it is connected to the network via a first wireless router 181 and the SSID and MAC address of the first wireless router 181 are stored in the storage 13. The notebook computer 180 is changed in place as illustrated, for example, in FIG. 18B, the neighboring second wireless routers 182 are searched for accessing the network. At this time, if the SSID or MAC address of the searched second wireless router 172 does not match the SSID or MAC address of the first wireless router 171 previously stored in the storage 13, the notebook computer 180 may send a preset user's smart phone 183 a message of warning that the service environment of the notebook computer 180 is not valid and information about the place of the notebook computer 180 [symbol] the place information.

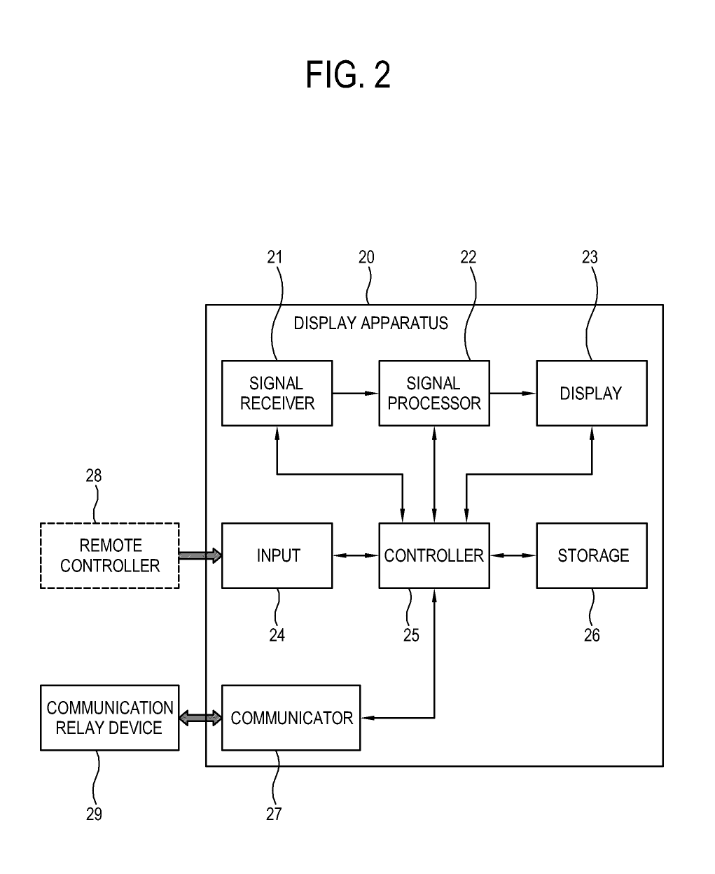

FIG. 2 is a block diagram illustrating an example display apparatus according to an example embodiment. As illustrated in FIG. 2, the display apparatus according to an example embodiment includes a signal receiver 21, a signal processor 22, a display 23, an input (e.g., including input circuitry for receiving, for example, a user input) 24, a controller 25, a storage 26 and a communicator (e.g., including communication circuitry) 27, and may for example be achieved by a smart TV, a smart phone, a tablet computer, a PC, a netbook computer, a notebook computer, etc.

The display apparatus 20 may connect with an communication relay device 29 through various communication circuitry including, for example, and without limitation, Wi-Fi or the like communication method. The communication relay device 29 serves as an access point (AP). The communication relay device 29 may for example be achieved by a wireless router. The display apparatus 20 may communicate with a remote controller 28 by an infrared communication method. The input 24 may receive a user's input from the remote controller 28. Among the elements of the display apparatus 20, the communicator 27, the storage and the input 24 respectively correspond to the communicator 14, the storage 13 and the input 11 of FIG. 1, and thus repetitive descriptions thereof will be avoided. The elements included in the display apparatus 20 are not limited to the foregoing embodiment, and may additionally include other elements.

The display apparatus 20 searches for the communication relay device 29, and accesses the network through the searched communication relay device 29. The display apparatus 20 stores the identification information of at least one communication relay device 29 previously used for the connection with the network. The display apparatus 20 receives the identification information of the searched communication relay device 29, and determines whether the service environment of the display apparatus 20 is valid, based on the received identification information and the stored identification information of at least one communication relay device. If it is determined that the service environment is not valid, the display apparatus 20 may perform the preset device-protecting operation.

Thus, the display apparatus 20 according to an example embodiment identifies the neighboring APs and determines whether the environment allows the display apparatus 20 to be used, thereby controlling the use of the display apparatus 20. Further, if the neighboring AP is identified but the service environment of the display apparatus 20 is not valid, the protecting operation may be automatically performed.

The signal receiver 11 receives a broadcast signal. The signal receiver 11 may be variously achieved in accordance with formats of the received broadcast signal and the types of the display apparatus 10. For example, the signal receiver 11 may be achieved by a tuner for receiving a radio frequency (RF) broadcast signal received from a broadcasting station or a satellite signal. Alternatively, the signal receiver 11 may receive an image signal from an external apparatus connected to the display apparatus 10, for example, a digital versatile disk (DVD) player or the like. Thus, the signal receiver 11 may be variously achieved to receive a broadcast signal without being limited to this example embodiment.

The signal receiver 21 receives a broadcast signal. The signal receiver 21 may be variously achieved in accordance with the formats of the broadcast signal to be received and the types of the display apparatus 20. For example, the signal receiver 21 may be achieved by a tuner that receives a radio frequency (RF) broadcast signal or satellite signal from a broadcasting station. Alternatively, the signal receiver 21 may receive an image signal from an external device connected to the display apparatus 20, for example, a digital versatile disc (DVD) player or the like. Thus, the signal receiver 21 is not limited to this example embodiment and may be achieved variously to receive a broadcast signal.

The signal processor 22 performs a signal processing process previously set to a broadcast signal received in the signal receiver 21. As an example of the signal processing process to be performed in the signal processor 22, there are decoding, de-interlacing, scaling, noise reduction, detail enhancement, but there are no limits to the kind of signal processing processes. The signal processor 22 may be achieved by a system-on-chip (SOC) where various functions are integrated, or image processing boards where individual elements for independently performing the respective processes are mounted.

The display 13 displays an image based on a broadcast signal processed by the signal processor 12. The display 13 may be achieved by various types. For example, the display 13 may be achieved by a plasma display panel (PDP), a liquid crystal display (LCD), an organic light emitting diode (OLED), a flexible display, etc.

The display 23 displays an image based on a broadcast signal processed by the signal processor 22. There are no limits to the type of the display 23. For example, the display 23 may be achieved in various forms such as a plasma display panel (PDP), a liquid crystal display (LCD), an organic light emitting diodes (OLED), a flexible display, etc.

The controller 25 receives identification information of the searched communication relay device 29 through the communicator 27. The identification information of the communication relay device 29 may include at least one of the SSID and the MAC address. The controller 25 determines whether the service environment of the display apparatus 20 is valid based on the received identification information of the communication relay device 29 and the stored identification information of at least one communication relay device. If it is determined that the service environment of the display apparatus 20 is not valid, the controller 25 controls the preset device-protecting operation to be performed.

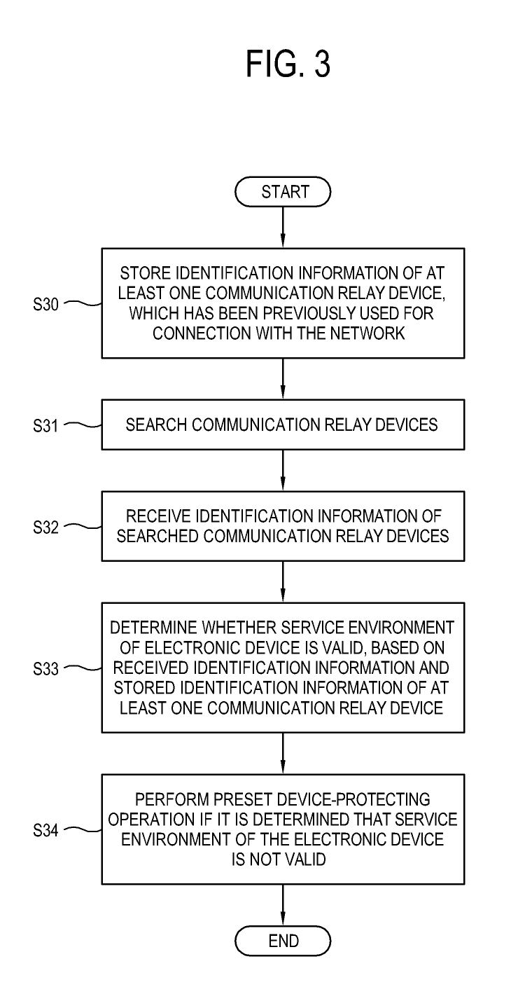

FIG. 3 is a flowchart illustrating an example of controlling the electronic device according to an example embodiment. As illustrated in FIG. 3, at operation S30, the identification information of at least one communication relay device, which has been previously used for connection with the network, is stored. The identification information of the communication relay device may include at least one of the SSID and the MAC address. Next, the communication relay device is searched at operation S31, and the identification information of the searched communication relay device is received at operation S32.

Next, at operation S33, it is determined whether the service environment of the electronic device is valid, based on the received identification information and the stored identification information of at least one communication relay device. The operation S33 may further include determining that the service environment of the electronic device is invalid if the received identification information does not match the identification information of at least one communication relay device.

According to an example embodiment, the operation S33 may further include determining whether the service environment of the electronic device is valid, based on a user's input, if the received identification information does not match the stored identification information of at least one communication relay device. The user's input may include at least one input among a numeral key, combination of buttons provided in the remote controller, and combination of panel keys provided outside the electronic device.

Alternatively, the operation S33 may further include determining whether the service environment of the electronic device is valid, based on whether communication with a preset user's wireless communication device is possible, if the received identification information does not match the stored identification information of at least one communication relay device.

Alternatively, the operation S33 may further include determining whether the service environment of the electronic device is valid, based on whether a picture of a surrounding environment taken by photographing the surrounding environment is similar to the previously stored picture of the surrounding environment, if the received identification information does not match the stored identification information of at least one communication relay device.

Lastly, at operation S34, if it is determined that the service environment of the electronic device is not valid, the preset device-protecting operation is performed. According to an example embodiment, the device-protecting operation may include preventing at least one function, which can be provided by the electronic device, from being implemented. Alternatively, the device-protecting operation may include sending a preset user's wireless communication device at least one of information of warning that the service environment of the electronic device is not valid, and information about the place of the electronic device.

According to an example embodiment, if the received identification information does not match the stored identification information of at least one communication relay device but the service environment of the electronic device is valid, there may be added an operation of storing the identification information of the received communication relay device in the storage.

According to an example embodiment, the operation S33 may include an operation of receiving a user's input for selecting a normal mode or an antitheft mode. If the antitheft mode is selected, there may be added an operation of determining whether or not the service environment of the electronic device is valid based on the received identification information and the stored identification information of at least one communication relay device.

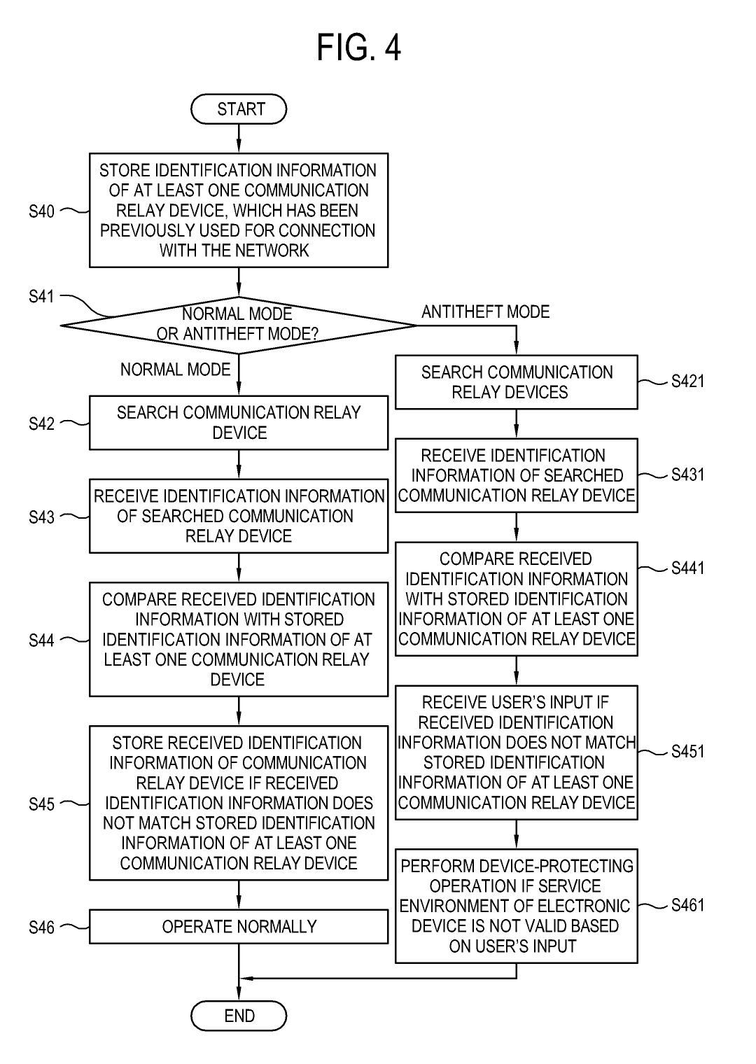

FIG. 4 is a flowchart illustrating an example of controlling the electronic device according to an example embodiment. As illustrated in FIG. 4, at operation S40, the identification information of at least one communication relay device, which has been previously used for connection with the network, is stored. Next, at operation S41, it is determined whether the electronic device is in the normal mode or the antitheft mode. If it is determined that the electronic device is in the normal mode, the communication relay device is searched at operation S42, and the identification information of the searched communication relay device is received at operation S43. At operation S44, the received identification information is compared with the stored identification information of at least one communication relay device. If the received identification information does not match the stored identification information of at least one communication relay device, at operation S45 the received identification information of the communication relay device is stored. At operation S46, the electronic device operates in the normal mode.

On the other hand, if it is determined in the operation S41 that the electronic device is in the antitheft mode, the communication relay device is searched at operation S421 and the identification information of the searched communication relay device is received at operation S431. At operation S441, the received identification information is compared with the stored identification information of at least one communication relay device. If the received identification information does not match the stored identification information of at least one communication relay device, at operation S451 a user's input is received for user authentication. Lastly, if the service environment of the electronic device is not valid based on the user's input, at operation S461 the device-protecting operation is performed. That is, it is determined whether or the service environment of the electronic device is valid based on matching between the received user's input and a user's preset password. If the received user's input does not match a user's preset password, the device-protecting operation may be performed.

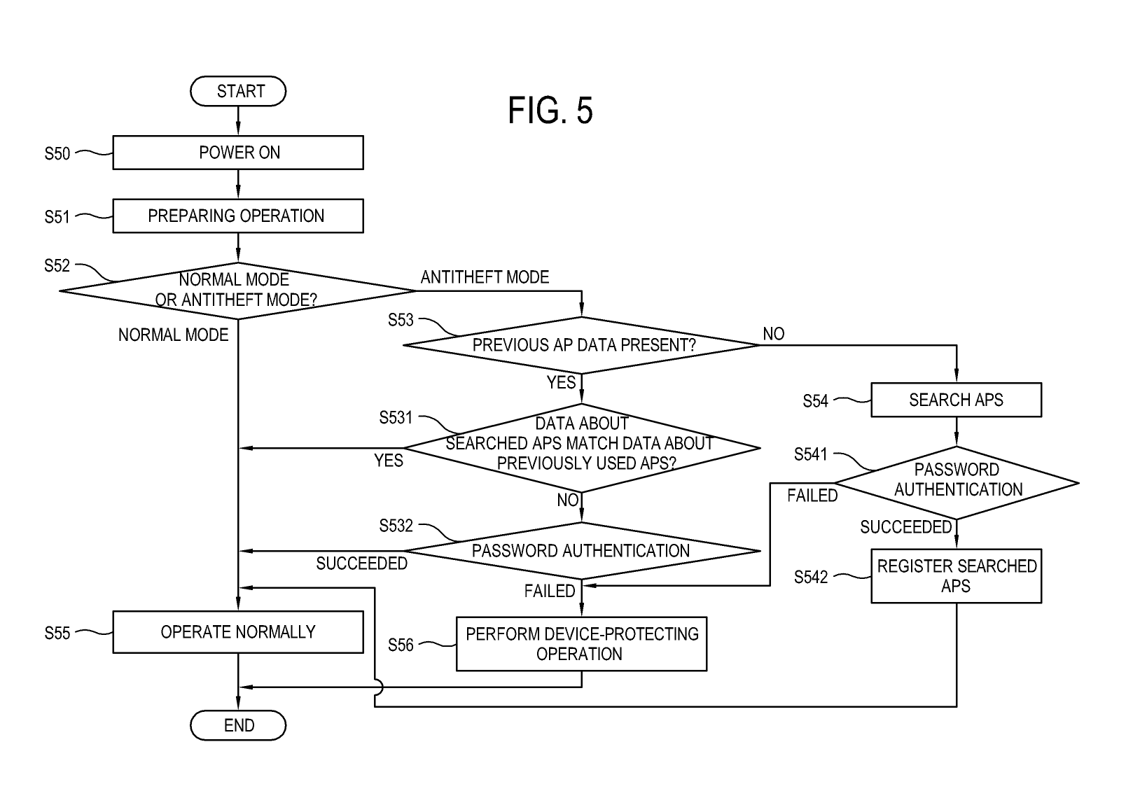

FIG. 5 is a flowchart illustrating an example of controlling the electronic device according to an example embodiment. As illustrated in FIG. 5, power is supplied at operation S50, and preparing operations for performing the functions of the electronic device are implemented at operation S51. Next, at operation S52 it is determined whether the electronic device is in the normal mode or the antitheft mode. If it is determined that the electronic device is in the normal mode, the electronic device operates in the normal mode at the operation S55.

On the other hand, if it is determined in the operation S52 that the electronic device is in the antitheft mode, it is determined at operation S53 whether there are data about previously used APs. If there are the data about the previously used APs, it is determined at operation S531 whether the data about the searched APs match the data about the previously used APs. At this time, if the data about the searched APs do not match the data about the previously used Aps, password authentication based on a user's input is performed at operation S532. If the password authentication is failed, the device-protecting operation is performed at operation S56. If the password authentication is successful in the operation S532, the electronic device operates in the normal mode at operation S55.

On the other hand, if it is determined in the operation S53 that there are no data about previously used APs, an AP is searched at operation S54 and the password authentication is performed at operation S541. If the password authentication is successful, the searched APs are registered at operation S542. If the password authentication is failed, the device-protecting operation is performed at operation S56.

FIG. 6 shows an example of registering access points (Aps) to which a user has an access in various places according to an example embodiment. As illustrated in FIG. 6, a notebook computer 60 can have an access to Internet through a first wireless router 61 and store the SSID and MAC address of the first wireless router 61 if it is used at home. Further, the notebook computer 60 can have an access to Internet through a second wireless router 62 if it is used at office and store the SSID and MAC address of the second wireless router 62. Further, the notebook computer 60 can have an access to Internet through a third wireless router 63 and store the SSID and MAC address of the third wireless router 63 if it is used at the outside. In this case, the third wireless router 63 may be a portable router. Like this, the notebook computer 60 registers at least one of the SSID and the MAC address, e.g., the identification information of the wireless routers respectively provided in various places, and loads the registered identification information of the wireless router corresponding to the place, to which a user carries the notebook computer 60, thereby directly connecting the network without any separate setting procedures.

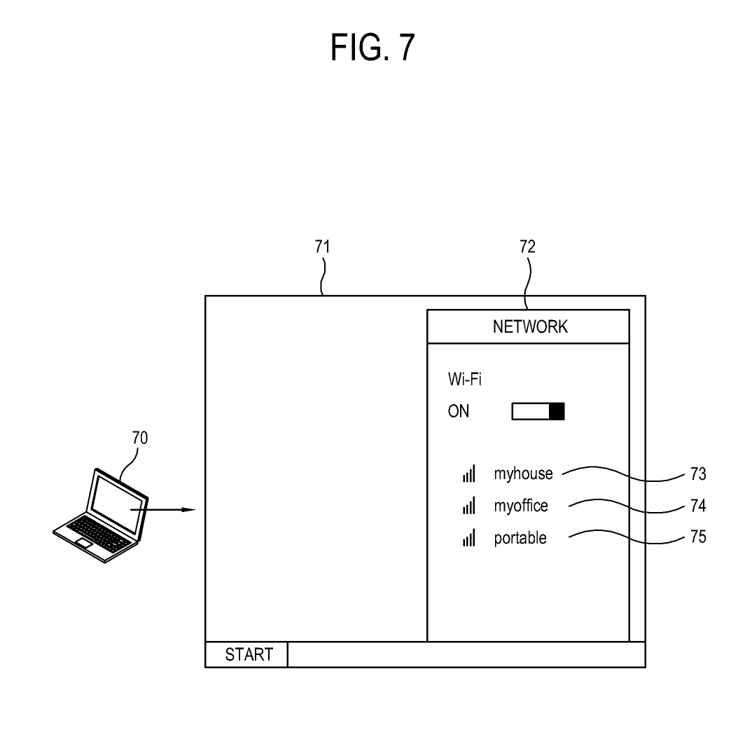

FIG. 7 is a diagram illustrating an example of displaying all the APs registered according to an example embodiment. As illustrated in FIG. 7, a notebook computer displays a network setup window 72 for setting and inquiring a network on a screen 71. The network setup window 72 shows APs registered by a user corresponding to various places. For example, the network setup window 72 shows “myhouse” 73 previously registered as an AP corresponding to home, and “myoffice” 74 previously registered as an AP corresponding to office. Further, the network setup window 72 shows “potable” 75 previously registered as a portable AP corresponding to the outside. Thus, all the APs, to which a user can have accesses at various places, are registered and managed.

FIGS. 8A and 8B are diagrams illustrating an example of determining change in place of the electronic device based on identification information of the AP searched according to an example embodiment. As illustrated in FIG. 8A, if the notebook computer 80 is being used at home, it is connected to the network through the first wireless router 81, and the SSID and MAC address of the first wireless router 81 are stored in the storage 13. If the notebook computer 80 is changed in place as illustrated, for example, in FIG. 8B, the neighboring second wireless routers 82 are searched for connection with the network. At this time, the SSID or MAC address of the searched second wireless routers 82 does not match the previously stored SSID or MAC address of the first wireless router 81, and it is therefore determined that the notebook computer 80 is in an invalid service environment, for example, the notebook computer 80 is stolen.

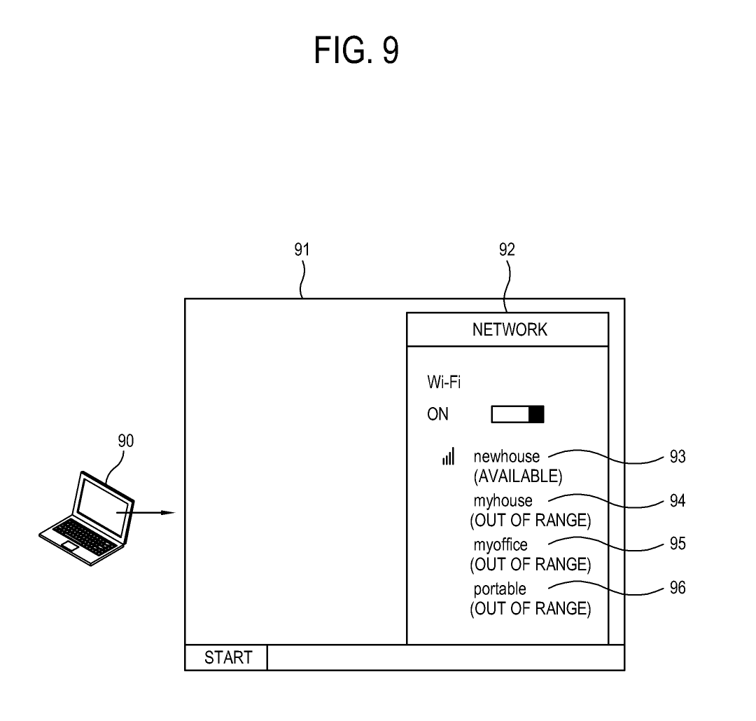

FIG. 9 is a diagram illustrating an example of displaying APs newly searched according to an example embodiment. As illustrated in FIG. 9, a notebook computer 90 displays a network setup window 92, showing that previously registered APs of “myhouse” 94, “myoffice” 95 and “portable” 96 get out of range and a newly searched AP of “newhouse” 93 is available, on a screen 91. In this case, the notebook computer 90 determines that the notebook computer 90 is changed in place since the SSID or MAC address of the searched “newhouse” 93 does not match the previously registered SSID or MAC address of one among the “myhouse” 94, “myoffice” 95 and “portable” 96.

FIG. 10 is a diagram illustrating an example of performing a device-protecting operation if the searched AP is not registered according to an example embodiment. As illustrated in FIG. 10, the notebook computer 101 displays the network setup window 102 showing that the previously registered APs such as “myhouse” 105, “myoffice” 106 and “portable” 107 get out of range and a newly searched AP such as “newhouse” 104 is available. The notebook computer 101 determines that the service environment of the notebook computer 101 is not valid since the SSID or MAC address of the searched “newhouse” 104 does not match the SSID or MAC address of one among the previously registered myhouse” 105, “myoffice” 106 and “portable” 107. At this time, the notebook computer 101 may display the warning window 103 and stop its own operations.

FIG. 11 is a diagram illustrating an example of displaying a user interface (UI) for performing user authentication if the searched AP is not registered according to an example embodiment. As illustrated in FIG. 11, the notebook computer 111 displays the network setup window 112 showing that the previously registered APs such as “myhouse” 115, “myoffice” 116 and “portable” 117 get out of range, and a newly searched AP of “newhouse” 114 is available. The notebook computer 111 may determine whether the service environment of the notebook computer 111 is valid or not, based on a user's input, since the SSID or MAC address of the searched “newhouse” 114 does not match the SSID or MAC address of one among “myhouse” 115, “myoffice” 116 and “portable” 117.

For example, the notebook computer 111 displays a UI 113 for user authentication, and receives a user's input, i.e. his/her password in order to determine whether the service environment is valid or not. If a user's password is input for the user authentication through the UI 113, the notebook computer 111 determines whether or not the service environment of the notebook computer 111 is valid, based on matching between the input password and the preset password. That is, if a user's input password matches a preset password, the notebook computer 111 determines that the service environment is valid, and operates in the normal mode.

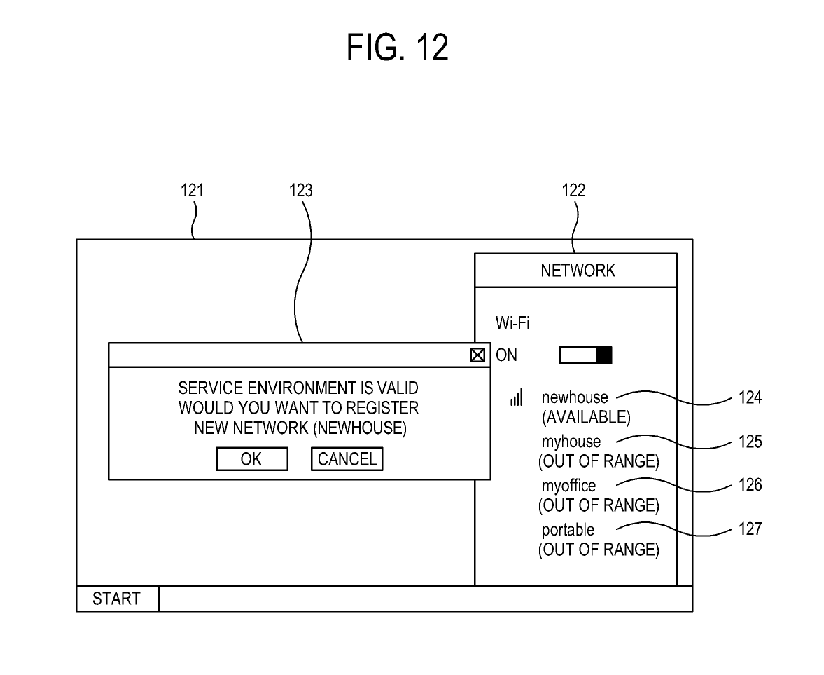

FIG. 12 is a diagram illustrating an example of displaying a UI for registering the searched AP by a user based on the user authentication according to an example embodiment. As illustrated in FIG. 12, a notebook computer 121 displays a network setup window 122 showing that the previously registered APs of “myhouse” 125, “myoffice” 126 and “portable” 127 get out of range, and a newly searched AP of “newhouse” 124 is available. The notebook computer 121 may select whether to register the newly searched AP of “newhouse” 124 if it is determined that the service environment is valid based on the user authentication or the like method even through the SSID or MAC address of the searched “newhouse” 124 does not match any one among the registered “myhouse” 125, “myoffice” 126 and “portable” 127. For example, the notebook computer 121 displays a registration window 123 for selecting whether to register the new AP if the service environment is valid, and registers the newhouse” 124 as an AP available to a user if the “OK” button is selected.

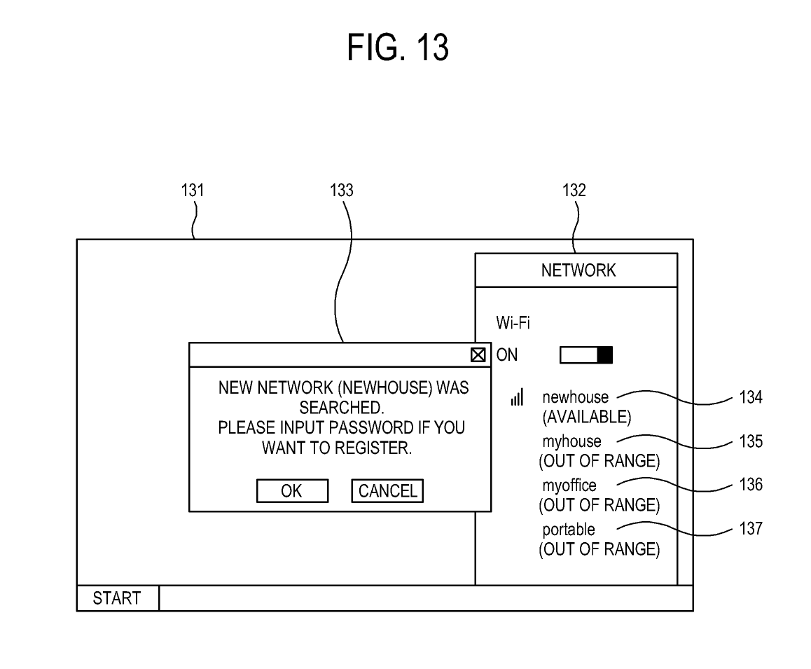

FIG. 13 is a diagram illustrating an example of displaying a UI for registering the searched AP based on the user authentication if the searched AP is not registered, according to an example embodiment. As illustrated in FIG. 13, a notebook computer 131 displays a network setup window 132 showing that the previously registered APs of “myhouse” 135, “myoffice” 136 and “portable” 137 get out of range and a newly searched AP of “newhouse” 134 is available. The notebook computer 131 may register the newly searched AP of “newhouse” 134 by the user authentication or the like method even though the SSID or MAC address of the searched “newhouse” 134 does not match the SSID or MAC address of any one among the previously registered “myhouse” 135, “myoffice” 136 and “portable” 137. For example, the notebook computer 131 displays a UI 133 for user authentication in order to register a new AP, and receives a user's input, i.e. his/her password. At this time, if a user's input password matches a preset password, the notebook computer 13 registers the “newhouse” 134 as an AP available to a user.

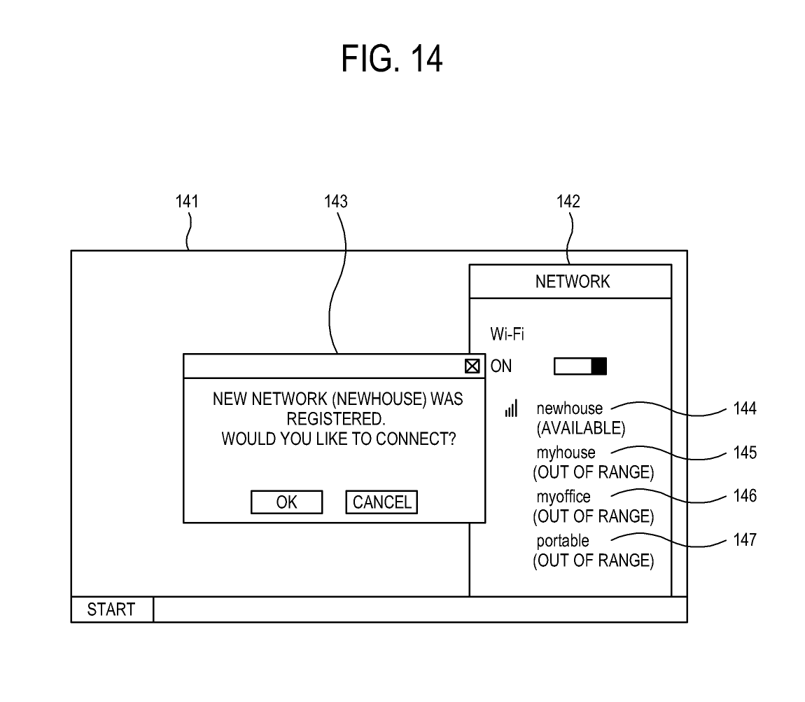

FIG. 14 is a diagram illustrating an example of displaying a UI for accessing the newly registered AP according to an example embodiment. As illustrated in FIG. 14, the notebook computer 141 displays a network setup window 142 showing that the previously registered APs of “myhouse” 145, “myoffice” 146 and “portable” 147 get out of range, and the newly searched AP of “newhouse” 144 is available. The notebook computer 141 may register the “newhouse” 144 as an AP available to a user by user authentication or the like method, even though the SSID or MAC address of the searched “newhouse” 144 does not match the SSID or MAC address of any one among the registered “myhouse” 145, “myoffice” 146 and “portable” 147. At this time, the notebook computer 141 may display a connection window 143 of asking whether to directly connect with the registered “newhouse” 144, and use Internet through the “newhouse” 144 if the “OK” button is selected.

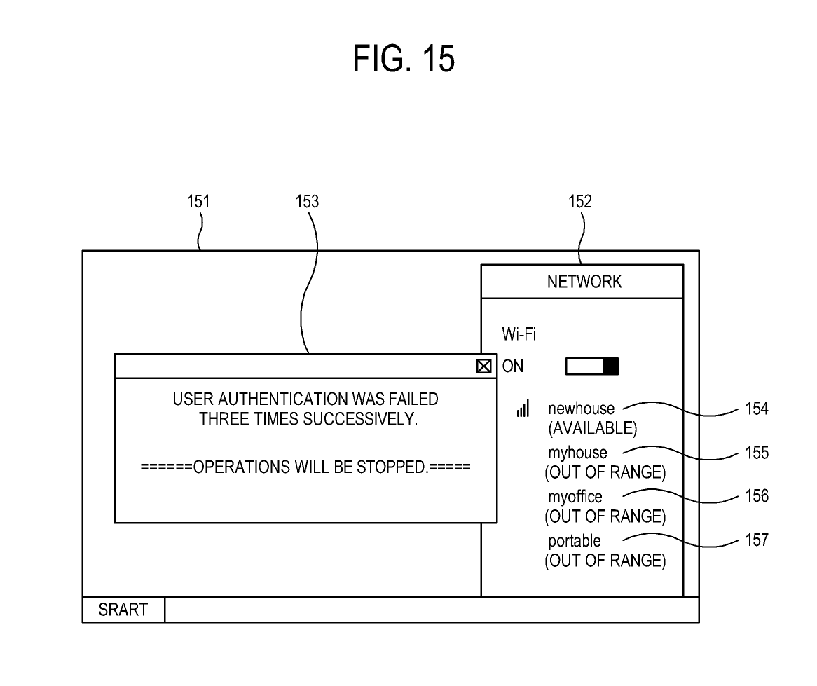

FIG. 15 is a diagram illustrating an example of performing the device-protecting operation when the user authentication is failed, according to an example embodiment. As illustrated in FIG. 15, a notebook computer 151 displays a network setup window 152 showing the previously registered APs such as “myhouse” 155, “myoffice” 156 and “portable” 157 get out of range, and a newly searched AP such as “newhouse” 154 is available. The notebook computer 151 determines whether the service environment is valid or not based on user authentication since the SSID or MAC address of the searched “newhouse” 154 does not match the SSID or MAC address of any one among the previously registered “myhouse” 155, “myoffice” 156 and “portable” 157. At this time, the user authentication is failed by a predetermined number or more of times, the notebook computer 151 displays a warning window 153 showing that the user authentication is failed, and stops operating.

FIGS. 16A and 16B are diagrams illustrating an example of determining whether communication with a user's wireless communication device is possible or not if the searched AP is not registered, according to an example embodiment. As illustrated in FIG. 16A, if the notebook computer 160 is being used at home, it is connected to Internet through the first wireless router 161, and the SSID and MAC address of the first wireless router 161 are stored. If the notebook computer 160 is changed in place as illustrated, for example, in FIG. 16B, the neighboring second wireless routers 162 are searched for accessing Internet. At this time, if the SSID or MAC address of the searched second wireless router 162 does not match the SSID or MAC address of the previously stored first wireless router 161, the notebook computer 160 makes an attempt to communicate with a user's smart phone 163 previously stored as his/her basic information. If the notebook computer 160 connects with a user's smart phone 163 through a short range communication such as Wi-Fi direct or Bluetooth, it is determined that the service environment of the notebook computer 160 is valid. On the other hand, if the notebook computer 160 fails in connection with a user's smart phone 163, it is determined that the service environment of the notebook computer 160 is not valid, i.e. stolen.

FIGS. 17A and 17B are diagrams illustrating an example of comparing a photographed picture of a surrounding environment with previously registered pictures of the surrounding environments if the searched AP is not registered, according to an example embodiment. As illustrated in FIG. 17A, if the notebook computer 170 is being used at home, it is connected to Internet through the first wireless router 171, and the SSID and MAC address of the first wireless router 171 are stored. Further, the notebook computer 170 takes a picture of a surrounding environment generally used by a user with a webcam and stores it. Here, the stored picture of the surrounding environment may include objects such as a sofa 173, a lamp 174, etc.

If the notebook computer 170 is changed in place as illustrated, for example, in FIG. 17B, the neighboring second wireless routers 172 are searched for accessing Internet. At this time, if the SSID or MAC address of the searched second wireless router 172 does not match the stored SSID or MAC address of the first wireless router 171, the notebook computer 170 activates the webcam and takes a picture of the surrounding environment. The picture of the surrounding environment, taken with the webcam, may include a desk 175, a person, and the like objects. The notebook computer 170 compares the taken picture of the surrounding environment with the stored picture of the surrounding environment and determines that the service environment of the notebook computer 170 is not valid if the pictures are different in objects contained therein.

FIGS. 18A and 18B are diagrams illustrating an example of transmitting warning information or place information to a user's wireless communication device if the searched AP is not registered, according to an example embodiment. As illustrated in FIG. 18A, if the notebook computer 180 is being used at home, it is connected to Internet through the first wireless router 181, and stores the SSID and MAC address of the first wireless router 181. If the notebook computer 180 is changed in place as illustrated, for example, in FIG. 18B, the neighboring second wireless routers 182 are searched for connection with the Internet. At this time, if the SSID or MAC address of the searched second wireless router 172 does not match the previously stored SSID or MAC address of the first wireless router 171, the notebook computer 180 may send a preset user's smart phone 183 a message of warning that the service environment of the notebook computer 180 is not valid, and information about the place of the notebook computer 180.

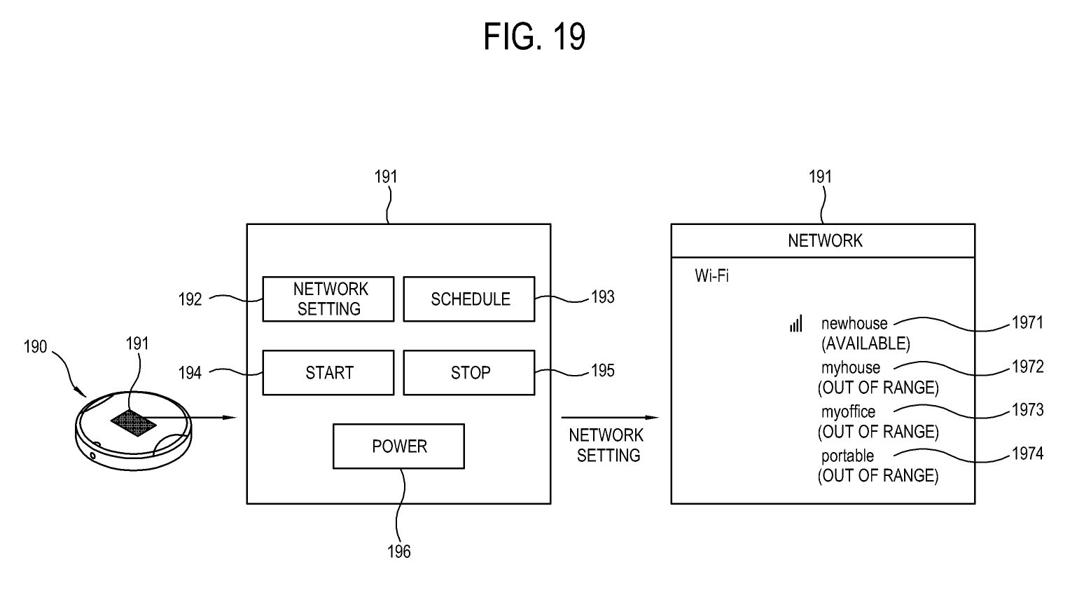

FIG. 19 is a diagram illustrating an example where new APs are searched as the electronic device according to an example embodiment is changed in place. A robot cleaner 190 is achieved by a product supporting a function of Wi-Fi, and includes a touch screen 191 having a predetermined size at the outer side thereof. The robot cleaner 190 may include a plurality of menu buttons such as “network setting” 192, “schedule” 193, “operation” 194, “stop” 195, “power” 196, etc. on the touch screen 191. When the button of “network setting” 192 on the robot cleaner 190 is touched, the touch screen 191 displays a UI for setting the network. The touch screen 191 displays a network setting UI showing that the previously registered APs of “myhouse” 1972, “myoffice” 1973 and “portable” 1974 get out of range and a newly searched AP of “newhouse” 1971 is available.

The robot cleaner 190 may determine that the service environment is not valid since the SSID or MAC address of the searched “newhouse” 1971 does not match the SSID or MAC address of any one among the previously registered “myhouse” 1972, “myoffice” 1973 and “portable” 1974. According to an example embodiment, if the robot cleaner 190 is in the antitheft mode, it is determined that the robot cleaner 190 is stolen when the previously stored SSID or MAC address of the AP does not match the SSID or MAC address of the searched AP. Alternatively, if the robot cleaner 190 is in the normal mode, the robot cleaner 190 may be determined as it is normal and performs operations even though the previously stored SSID or MAC address of the AP does not match the SSID or MAC address of the searched AP.

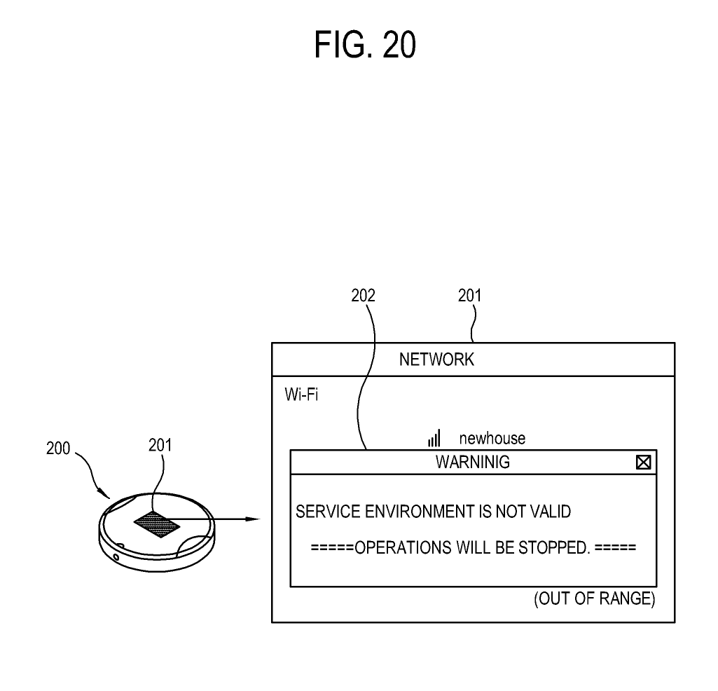

FIG. 20 is a diagram illustrating an example of performing the device-protecting operation if the searched AP is not registered, according to an example embodiment. As illustrated in FIG. 20, a robot cleaner 200 supporting a function of Wi-Fi makes a touch screen 201 display that the previously registered APs of “myhouse”, “myoffice” and “portable” get out of range and a newly searched AP of “newhouse” is available. The robot cleaner 200 makes the touch screen 201 display a warning window 202 showing that the service environment is not valid, since the SSID or MAC address of the searched “newhouse” does not match the SSID or MAC address of any one among the previously registered “myhouse”, “myoffice” and “portable”, and straightly stops its operations.

According to an example embodiment, the robot cleaner 200 compares the previously registered AP and the searched AP with respect to the SSID or the MAC address, and sends a user's device such as a smart phone, a tablet computer, etc. warning information or place information if the previously registered AP does not match the searched AP.

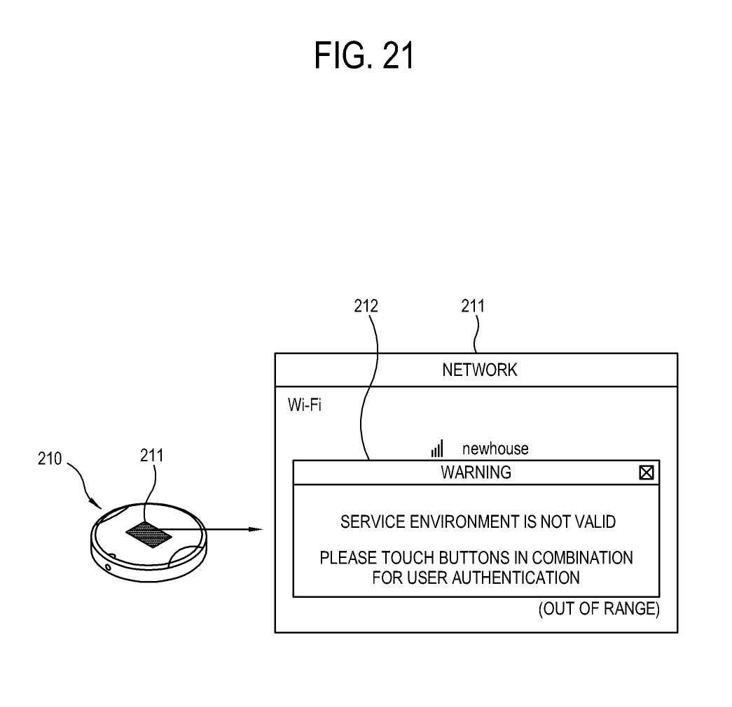

FIG. 21 is a diagram illustrating an example of displaying a UI for performing the user authentication if the searched AP is not registered, according to an example embodiment. As illustrated in FIG. 21, a robot cleaner 210 supporting a function of Wi-Fi makes a touch screen 211 display that the previously registered APs of myhouse”, “myoffice” and “portable” get out of range and a newly searched AP of “newhouse” is available. The robot cleaner 210 may display a warning window 212 for requesting user authentication due to the invalid service environment on the touch screen 211 since the SSID or MAC address of the searched “newhouse” does not match the SSID or MAC address of any one among the previously registered “myhouse”, “myoffice” and “portable”. For example, the user authentication may be carried out by touching the buttons “schedule”, “start” and “stop” displayed on the touch screen 211 of the robot cleaner 210 in accordance with preset combination or order. Here, the robot cleaner 210 operates normally if a user succeeds in the user authentication, but stops operating if s/he fails in the user authentication.

Alternatively, if the robot cleaner 210 operates by the buttons provided at the outer side without the touch screen 211, the user authentication may be achieved by selecting the buttons in accordance with preset combination or order.

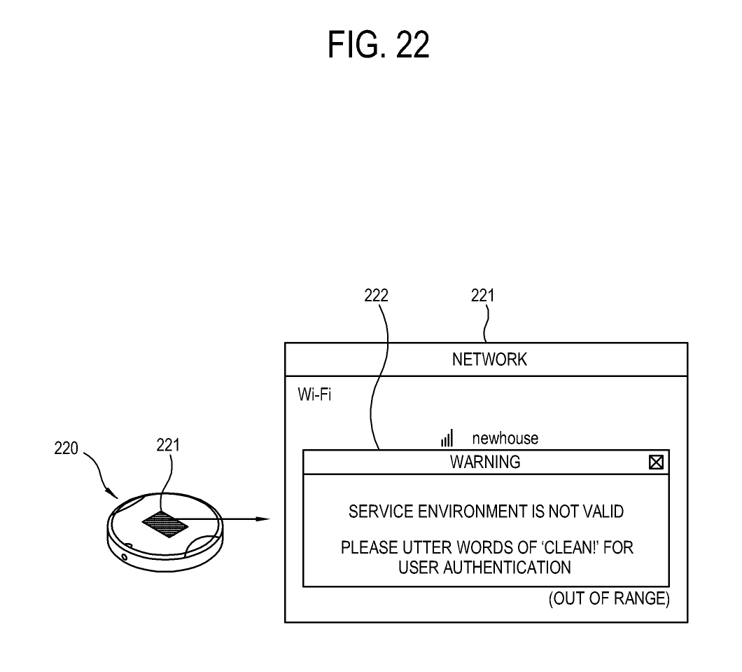

FIG. 22 is a diagram illustrating an example of performing the user authentication based on voice recognition if the searched AP is not registered, according to an example embodiment. As illustrated in FIG. 22, the robot cleaner 220 having a Wi-Fi function makes a touch screen 221 display that the previously registered APs of “myhouse”, “myoffice” and “portable” get out of range, and a newly searched AP of “newhouse” is connectable. The robot cleaner 220 may make the touch screen 211 display a warning window 222 for requesting user authentication based on voice recognition since the SSID or MAC address of the searched “newhouse” does not match the SSID or MAC address of the previously registered “myhouse”, “myoffice” and “portable”. For example, the robot cleaner 220 may make the warning window 222 display a method of the user authentication, e.g. making a user utter ‘Clean!’ If a user utters ‘Clean!’ the robot cleaner 220 implements the voice recognition and determines whether this utterance is similar to a user's preset voice. Here, the robot cleaner 220 operates normally if it is determined that a user's utterance is similar to the preset voice, but stops operating if it is determined that the utterance is not similar to the preset voice.

Alternatively, the robot cleaner 220 may implement the user authentication by motion recognition, face recognition, fingerprint recognition, etc. as well as the voice recognition. Besides, the user authentication may be performed variously without limitations to the foregoing embodiments.

As described above, the electronic device according to an example embodiment identifies the neighboring APs and determines whether or not the service environment of the electronic device is valid.

Further, the electronic device according to an example embodiment automatically performs the device-protecting operation if the neighboring APs are identified but the service environment of the electronic device is not valid.

Although various example embodiments have been illustrated and described, it will be appreciated by those skilled in the art that changes may be made in these example embodiments without departing from the principles and spirit of the disclosure, the scope of which is defined in the appended claims and their equivalents.

What is claimed is:

1. An electronic device comprising:
a communicator including communication circuitry configured to communicate with a communication relay device to connect with a network through the communication relay device;
a storage; and
a controller configured:
to store first identification information of a first communication relay device with which the communicator is connected, in the storage,
in response to receiving an input for a connection to a second communication relay device, to compare the stored first identification information of the first communication relay device and second identification information of the second communication relay device to be connected, and
to determine whether to perform a preset protecting operation based on a result of the comparison.

2. The electronic device according to claim 1, wherein the controller is configured to perform the preset protecting operation, if the stored first identification information of the first communication relay device does not match the second identification information of the second communication relay device to be connected.

3. The electronic device according to claim 1, further comprising input circuitry configured to receive a user input, wherein
the controller is configured to determine whether to perform the preset protecting operation based on the user input, if the stored first identification information of the first communication relay device does not match the second identification information of the second communication relay device to be connected.

4. The electronic device according to claim 3, wherein the user input includes at least one input among a numeral key, combination of buttons provided in the remote controller, and combination of panel keys of the electronic device.

5. The electronic device according to claim 1, wherein the controller is configured to determine whether to perform the preset protecting operation based on whether communication with a preset wireless communication device is possible, if the stored first identification information of the first communication relay device does not match the second identification information of the second communication relay device to be connected.

6. The electronic device according to claim 1, further comprising a camera configured to capture an image of a surrounding environment, wherein
the controller is configured to determine whether to perform the preset protecting operation, based on whether the image of the surrounding environment captured by the camera is similar to one of previously stored images of surrounding environments, if the stored first identification information of the first communication relay device does not match the second identification information of the second communication relay device to be connected.

7. The electronic device according to claim 1, wherein the protecting operation comprises preventing at least one function, which can be provided by the electronic device, from being implemented.

8. The electronic device according to claim 1, wherein the protecting operation comprises sending a preset wireless communication device at least one of a warning message and information about a location of the electronic device.

9. The electronic device according to claim 1, wherein the identification information of the communication relay device comprises at least one of a service set identifier (SSID) and a media access control (MAC) address.

10. The electronic device according to claim 1, wherein the controller is configured to control the storage to store the second identification information of the second communication relay device to be connected if the stored first identification information of the first communication relay device does not match the second identification information of the second communication relay device to be connected and the preset protecting operation is not performed.

11. The electronic device according to claim 1, further comprising input circuitry configured to receive a user input, wherein
the controller is configured to receive the user input selecting a normal mode or an antitheft mode, and to determine whether to perform the preset protecting operation based on a result of the comparison, if an antitheft mode is selected.

12. A method of controlling an electronic device, the method comprising:
storing first identification information of first communication relay device with which a communicator is connected;
in response to receiving an input for a connection to a second communication relay device, comparing the stored first identification information of the first communication relay device and second identification information of the second communication relay device to be connected; and determining whether to perform a preset protecting operation based on a result of the comparison.

13. The method according to claim 12, further comprising performing the preset protecting operation, if stored first the identification information of the first communication relay device does not match the second identification information of the second communication relay device to be connected.

14. The method according to claim 12, further comprising determining whether to perform the preset protecting operation based on a user input, if the stored first identification information of the first communication relay device does not match the second identification information of the second communication relay device to be connected.

15. The method according to claim 14, wherein the user input include at least one of an input from among a numeral key, a combination of buttons provided in the remote controller, and a combination of panel keys of the electronic device.

16. The method according to claim 12, further comprising determining whether to perform the preset protecting operation based on whether communication with a preset wireless communication device is possible, if the stored first identification information of the communication relay device does not match the second identification information of the second communication relay device to be connected.

17. The method according to claim 12, further comprising determining whether to perform the preset protecting operation based on whether an image of a surrounding environment is similar to one of previously stored images of surrounding environments, if the stored first identification information of the first communication relay device does not match the second identification information of the second communication relay device to be connected.

18. The method according to claim 12, wherein the protecting operation comprises preventing at least one function, which can be provided by the electronic device, from being implemented.

19. The method according to claim 12, wherein the protecting operation comprises sending a preset wireless communication device at least one of a warning message and information about a location of the electronic device.

20. The method according to claim 12, wherein the identification information of the communication relay device comprises at least one of a service set identifier (SSID) and a media access control (MAC) address.
